(19) United States
(12) Patent Application Publication
(10) Pub. No.: US 2020/0004951 A1
(43) Pub. Date: Jan. 2, 2020

(54) COMPUTING SYSTEMS AND METHODS

(71) Applicant: GOPC PTY LTD, Perth, Western Australia (AU)

(72) Inventors: Graeme Speak, West Perth, Western Australia (AU); Neil Richardson, Perth, Western Australia (AU)

(73) Assignee: GOPC PTY LTD, Perth, Western Australia (AU)

(21) Appl. No.: 16/490,794

(22) PCT Filed: Mar. 3, 2018
(86) PCT No.: PCT/IB2018/051362

§ 371 Date: Sep. 3, 2019

(30) Foreign Application Priority Data
Mar. 3, 2017 (AU) 2017900748

(51) Int. Cl. G06F 21/44; G06F 13/42; G06F 21/57; G06F 21/34; H04L 9/06; H04W 12/06

(52) U.S. Cl. CPC G06F 21/44; G06F 13/4282; G06F 21/575; G06F 21/34; H04L 2209/38; H04L 9/0637; H04W 12/06; G06F 2213/0042; H04L 9/0631

(57) ABSTRACT

In one preferred form of the present invention shown in in FIG. 1 there is provided a computer implemented method 10. The method comprises: (A) providing at least one mobile electronics device, each device having a data store comprising a first area and a second area; the second area being distinct from the first area to assist with securing the first area; the first area being a system area and the second area for storing personal information; and (B) in connection with each mobile electronic device: associating personal information with computer identifying information to provide special personal information; storing the special personal information in the second area; and retrieving the personal information by: (i) reading the special personal information from the second area; and (ii) applying the computer identifying information to the special personal information.

### INCORPORATION BY REFERENCE

The present application claims priority from Australian Provisional Application 2017900748 entitled ‘COMPUTING SYSTEMS AND METHODS’ filed 3 Mar. 2017. All parts and elements of Australian Application 2017900748 are hereby fully incorporated by reference for all purposes.

### FIELD OF THE INVENTION

The present invention concerns computing systems and methods. In one particularly preferred form of the present invention there is provided a security device for providing a secure financial interface allowing a user to access his or her bank account.

### BACKGROUND TO THE INVENTION

For a user to access his or her online financial account, the user generally must connect through an HTML browser that is connected to the Internet. The user generally then must enter in a username and a password before the user is provided with access. Examples of financial accounts include bank accounts, asset portfolios, trust accounts, and so forth.

It is to be recognised that any discussion in the present specification is intended to explain the context of the present invention. It is not to be taken as an admission that the material discussed formed part of the prior art base or relevant general knowledge in any particular country or region.

It is against this background and the problems and difficulties associated therewith that the inventor has developed the present invention.

### SUMMARY OF THE INVENTION

According to an aspect of embodiments herein described there is provide a computer implemented method comprising: (A) providing at least one mobile electronics device, each device having a data store comprising a first area and a second area; the second area being distinct from the first area to assist with securing the first area; the first area being a system area and the second area for storing personal information; and (B) in connection with each mobile electronic device: associating personal information with computer identifying information to provide special personal information; storing the special personal information in the second area; and retrieving the personal information by: (i) reading the special personal information from the second area; and (ii) applying the computer identifying information to the special personal information.

In some embodiments, the first area comprises a locked down system area; the second area comprises an authentication area and the personal information comprises authentication data.

In some embodiments, in connection with each mobile electronic device: the first area comprises a read-only partition; and the second area comprises a read-write partition.

In some embodiments, the personal information comprises password, wallet or key data.

In some embodiments, the personal information comprises personal financial data.

In some embodiments, the personal information comprises a WIFI network password.

In some embodiments, each mobile electronic device comprises a dedicated storage device.

In some embodiments, the dedicated storage device comprises a USB thumb drive.

In some embodiments, the first area comprises a locked down system area; the second area comprises an authentication area; and the authentication area is no more than 10 MB in size.

In some embodiments, the first area comprises a locked down system area; the second area comprises an authentication area; and the authentication area is no more than 5 MB in size.

In some embodiments, the first area comprises a locked down system area; the second area comprises an authentication area; and the authentication area is greater than 1 MB in size.

In some embodiments, the first area comprises a locked down system area; the second area comprises an authentication area; and the operating system area is greater than 400 MB in size.

In some embodiments, associating the personal information with the computer identifying information to provide the special personal information comprises encrypting the personal information using the computer identifying information as the encryption password.

In some embodiments, applying computer identifying information to the special personal information comprises decrypting the special authentication data using the computer identifying information.

In some embodiments, the personal information comprises a WIFI network password.

In some embodiments, the first area comprises a locked down operating system area; the second area comprises an authentication area; and the method includes, in connection with each mobile electronic device, booting a computer using the operating system area and, when the computer identifying information corresponds with the computer, automatically logging onto the associated WIFI network using the WIFI password.

In some embodiments, the first area comprises a locked down operating system area; the second area comprises an authentication area; the operating system area comprises a read-only partition and the authentication area comprises a read-write partition; associating the WIFI network password with the computer identifying information to provide the special authentication data comprises encrypting the WIFI network password using the computer identifying information as the password; and applying computer identifying information to the special authentication data comprises decrypting the special authentication data using the computer identifying information.

In some embodiments, the computer identifying information is unique to a corresponding host computer such that the personal information of each mobile device is locked to a particular host computer due to the computer identifying information.

In some embodiments, any changes to the first area are lost when the host computer is powered off or rebooted; and the personal information of the second area is persistent between reboots and power cycles of the host computer.

In some embodiments, the personal information is encrypted via the Advanced Encryption Standard (AES) with 128 or more bit encryption keys with a cypher block chaining mode of operation.

In some embodiments, the computer identifying information comprises a unique hardware identifier.

In some embodiments, the unique hardware identifier comprises a CPU serial number or network MAC address associated with a corresponding computer.

In some embodiments, the personal information comprises an electronic wallet.

In some embodiments, the personal information comprises a block-chain private key.

In some embodiments, the personal information comprises a block-chain private key for electronic currency.

In some embodiments, the personal information comprises a private key.

According to an aspect of embodiments herein described there is provide a computer implemented method comprising: (A) providing at least one mobile electronics device, each device having a data store comprising an operating system area and an authentication area; the authentication area being distinct from the operating system area to assist with securing the operating system area; the authentication area for storing authentication data; and (B) in connection with each mobile electronic device: associating authentication data with computer identifying information to provide special authentication data; storing the special authentication data in the authentication area; and retrieving said authentication data by: (i) reading the special authentication data from the authentication area; and (ii) applying the computer identifying information to the special authentication data.

According to an aspect of embodiments herein described there is provide a computer implemented method comprising the steps of: (A) providing USB devices having a first partition and a second partition; each first partition storing an operating system configured to be loaded upon booting a computer using the USB device; each first partition being a read only partition; each second partition being a read-write partition; (B) in connection with each USB device: encrypting WIFI network password data with computer identifying information that uniquely identifies a computer to provide encrypted WIFI network authentication data; storing the encrypted WIFI network authentication data in the second partition; and retrieving said WIFI network password data by: (i) reading the encrypted WIFI network authentication data from the second partition; and (ii) applying the computer identifying information to the encrypted WIFI network authentication data by using the computer identifying information as a decryption password.

According to an aspect of embodiments herein described there is provide a computer implemented system comprising: a plurality of USB devices each having a first partition and a second partition; each first partition storing an operating system configured to be loaded upon booting a computer using the USB device; each first partition being a read only partition; each second partition being a read-write partition; each operating system including: (A) an encryption facility for encrypting WIFI network password data with computer identifying information that uniquely identifies a computer to provide encrypted WIFI network authentication data; (B) a storage facility for storing the encrypted WIFI network authentication data in the second partition; and (C) a retrieval facility for retrieving said WIFI network password data by: (i) reading the encrypted WIFI network authentication data from the second partition; and (ii) applying the computer identifying information to the encrypted WIFI network authentication data by using the computer identifying information as a decryption password.

According to an aspect of embodiments herein described there is provide a storage device comprising: a first area and a second area; the second area being distinct from the first area to assist with securing the first area; the first area being a system area and the second area for storing personal information; the first area including: (A) an associator for associating personal information with computer identifying information to provide special personal information; (B) a storage facility for storing the special personal information data in the second area; and (C) a retrieval facility for retrieving said personal information by: (i) reading the special personal information from the second area; and (ii) applying the computer identifying information to the special personal information.

According to an aspect of embodiments herein described there is provide a storage device comprising: a first partition and a second partition; the first partition storing an operating system configured to be loaded upon booting a computer using the USB device; each first partition being a read only partition; each second partition being a read-write partition; each operating system including: (A) an encryption facility for encrypting WIFI network password data with computer identifying information that uniquely identifies a computer to provide encrypted WIFI network authentication data; (B) a storage facility for storing the encrypted WIFI network authentication data in the second partition; and (C) a retrieval facility for retrieving said WIFI network password data by: (i) reading the encrypted WIFI network authentication data from the second partition; and (ii) applying the computer identifying information to the encrypted WIFI network authentication data by using the computer identifying information as a decryption password. According to an aspect of embodiments herein described there is provide a computer implemented method comprising: (A) providing a plurality of mobile electronics devices, each device having a data store comprising a first area; (B) providing an external data store external to the mobile electronics devices; each first area being a system area and the external data store for storing personal information; and (C) in connection with each mobile electronic device: associating personal information with computer identifying information to provide special personal information; storing the special personal information in the external data store; and retrieving the personal information by: (i) reading the special personal information from the external data store; and (ii) applying the computer identifying information to the special personal information.

In some embodiments, the personal information comprises password, wallet or key data.

In some embodiments, the personal information comprises personal financial data.

In some embodiments, associating the personal information with the computer identifying information to provide the special personal information comprises encrypting the personal information using the computer identifying information as the encryption password.

In some embodiments, applying computer identifying information to the special personal information comprises decrypting the special authentication data using the computer identifying information.

In some embodiments, each first area comprises a locked down operating system area; the second area comprises an authentication area.

Preferably the mobile electronic devices each comprise a USB devices having a first partition. Each first partition is provided for storing an operating system configured to be loaded upon booting a computer using the USB device; each first partition being a read only partition.

In some embodiments personal information is encrypted in the data store via the internet is a state that the encrypted using computer identifying information that identifies the computer allocated to the USB device.

According to an aspect of embodiments herein described there is provide a computer implemented method comprising: (i) providing users with user accounts; (ii) providing the users with first virtual machines in association with local electronic devices of the users; (iv) receiving user data from the users where each user is provided with the ability to store data in association with the user account of the user; and (iv) encrypting the user data of each user based on computer identifying information of an associated local electronics device of the user.

Preferably the computer identifying information of each local electronics device comprises a unique hardware identifier of the local electronics device

Preferably the method includes storing the unique hardware identifiers the local electronics devices in a data store of encryption keys; and associating the encryption keys with corresponding user accounts.

Preferably the method includes decrypting the data of each user based on the unique hardware identifier of the associated local electronics device of the user.

Among a number of other advantages, several preferred embodiments of the present invention are considered to provide:
a) the ability to store personal information on a USB flash drive providing a locked down operating system where the personal information is tied to a particular host computer;
b) the ability to quickly log on to a Wi-Fi network using a USB flash drive that provides a bootable operating system that provides a remote desktop connection to an online financial account;
c) the ability to store at private key on a USB thumb drive that provides a bootable operating system providing a remote desktop connection to an online financial account, where the private key is tied to a particular host computer; and
d) the ability to store a crypto currency private key on a USB thumb drive that provides a bootable operating system providing a remote desktop connection to a financial system, where the private key is tied to a particular host computer.

It is to be recognised that other aspects, preferred forms and advantages of the present invention will be apparent from the present specification including the detailed description, drawings and claims.

### BRIEF DESCRIPTION OF DRAWINGS

In order to facilitate a better understanding of the present invention, several preferred embodiments will now be described with reference to the accompanying drawings, in which:

FIG. 1 provides an illustration of a computer implemented method according to a first preferred embodiment of the present invention.

FIG. 2 provides a schematic illustration of a USB flash drive used in the method shown in FIG. 1, the USB flash drive providing a further preferred embodiment.

FIG. 3 provides an illustration of a computer implemented method according to another preferred embodiment of the present invention.

FIG. 4 provides an illustration of the working of the method illustrated in FIG. 3.

FIG. 5 provides an illustration of a computer implemented method according to another preferred embodiment of the present invention.

FIG. 6 provides an illustration of a computer implemented system according to another preferred embodiment of the present invention.

FIG. 7 provides an illustration of a USB flash drive device used in the system shown in FIG. 6, the USB flash drive providing a further preferred embodiment.

### DETAILED DESCRIPTION OF THE EMBODIMENTS

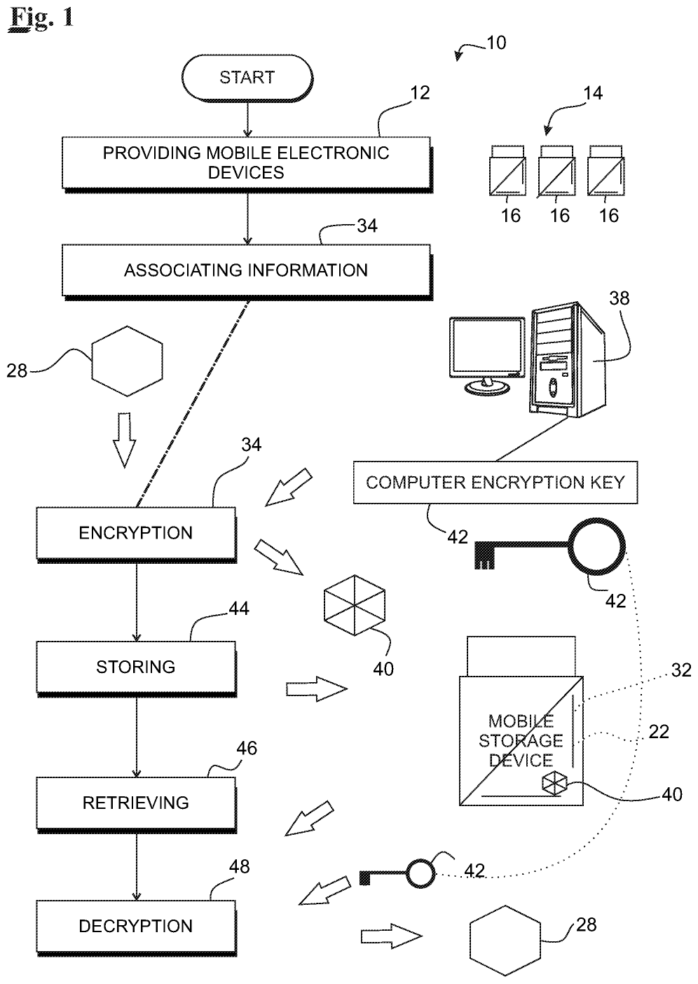

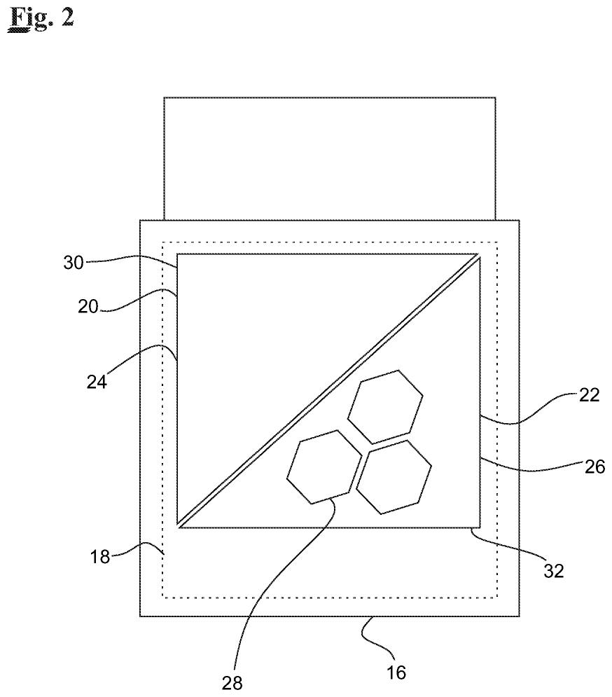

Referring to FIG. 1 there is shown a computer implemented method 10 according to a first preferred embodiment of the present invention. The computer implemented method 10 is considered to allow for the advantageous storage of personal information in the form of Wi-Fi login passwords and block chain private keys for use in the provision of a remote desktop. The remote desktop provides dedicated access to an online financial account.

International patent application PCT/AU2015/050758 filed on 1 Dec. 2015 in the name of GOPC Pty Ltd is hereby incorporated by reference for all purposes. The international patent application describes systems and methods that provide a secure banking interface in relation to an online financial account. Various security devices are described that provide a locked down system environment that is directed towards preventing third-party attacks.

In relation to PCT/AU2015/050758, a minimum operating environment is provided to allow banking operations via secured remote desktop services. The system is locked down to both external parties trying to gain access through the network and to the user. The user only has access to the remote connection facilities to make the connection to a virtual computer that provides access to the online financial account. In one embodiment a USB device is provided whereby the operating system is limited to providing remote protocol functionality that connects to the virtual computer service. The remote desktop is limited to providing access to a banking application running on the remote desktop.

Referring to FIG. 1, at block 12 the method 10 includes providing a plurality of mobile electronic devices 14. The mobile electronic devices 14 comprise universal serial bus storage devices 16 (USB devices). The USB devices 16 are each dedicated to the provision of data storage and comprise USB flash drives.

As detailed on Wikipedia: ‘A USB flash drive consists of a small printed circuit board carrying the circuit elements and a USB connector, insulated electrically and protected inside a case which can be carried in a pocket or on a key chain, for example. The USB connector may be protected by a removable cap or by retracting into the body of the drive, although it is not likely to be damaged if unprotected. Most flash drives use a standard type-A USB connection allowing connection with a port on a personal computer, but drives for other interfaces also exist. USB flash drives draw power from the computer via the USB connections.

Referring to FIG. 2, each device 16 provides a data store 18 comprising a first area 20 and a second area 22. The second area 22 is distinct from the first area 20 to assist with securing the first area 20. The first area 20 of each device 16 comprises a locked down system area 24. The second area 26 comprises an authentication area 26 and is provided for storing personal information 28.

With each device 16, the first area 20 comprises a read-only partition 30 and the second area 22 comprises a read-write partition 32. By providing the read-only partition 30 the first area 20 can provide a locked down operating system area 24. The read-write partition 32 is utilised as discussed below.

As would be apparent a partition comprises a region on a storage device that has been formatted so that an operating system can manage information in each region separately. Various partition types are used by different operating systems. The partitions comprise disk partitions of the dedicate storage devices.

In connection with the read write partition 32, the method 10 at block 34 includes associating personal information 28 with computer identifying information 38 to provide special personal information 40. In this embodiment, the computer identifying information 38 is used as an encryption key 42.

At block 44, the method 10 includes storing the special personal information 40 in the read-write partition 32. At block 46, the method 10 includes retrieving the personal information 28 by: (i) reading the special personal information 40 from the second area 22 and (ii) applying the computer identifying information 42 to the special personal information 40. As shown in FIG. 1 the process of retrieving includes decrypting the special personal information 40 at block 48.

The personal information 28 comprises authentication data 28. The second area 22 comprises an authentication area 22 for storing the authentication data 28. The authentication data 28 could comprise password, wallet or key data. Examples of password data include WIFI SSID/password pairs for logging into WIFI networks. Examples of wallet data include BITCOIN private keys that are able to be used to transfer electronic currency in relation to a publicly accessible ledger.

BITCOIN is a crypto currency and payment system based on a peer to peer model where transactions take place between users directly. The BITCOIN blockchain provides a publicly distributed leger where bitcoins comprise units of each transaction. The system is cryptographic requiring the use of keys to validate transactions. Bitcoins are presently created as a reward for computer power that verifies and records bitcoin transaction in the block chain. Users are able to pay for optional transaction fees to miners.

It is envisaged that the authentication data 28 in other embodiments could comprise a BLOCKCHAIN private key. Keys for providing access to data and information are considered to fall within the expression authentication data 28. In the case of Bitcoin, without a key, a transaction cannot be signed and therefore the currency cannot be spent.

It is to be appreciated that in other embodiments the personal information could comprise personal financial data including bank account numbers and transactions. Other applications include encrypted wallets of digital currency.

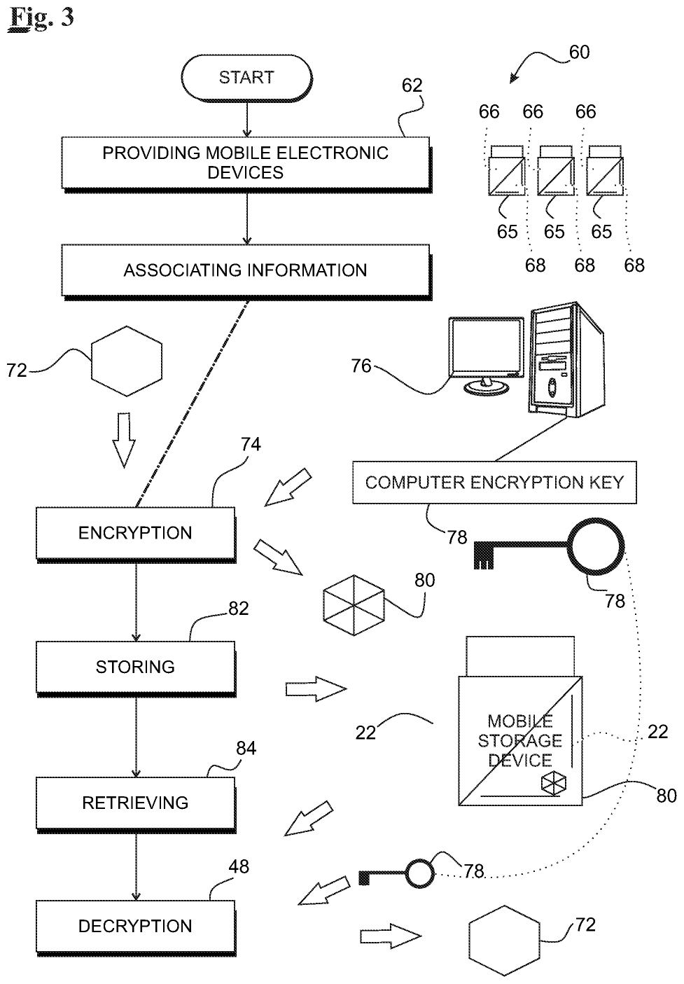

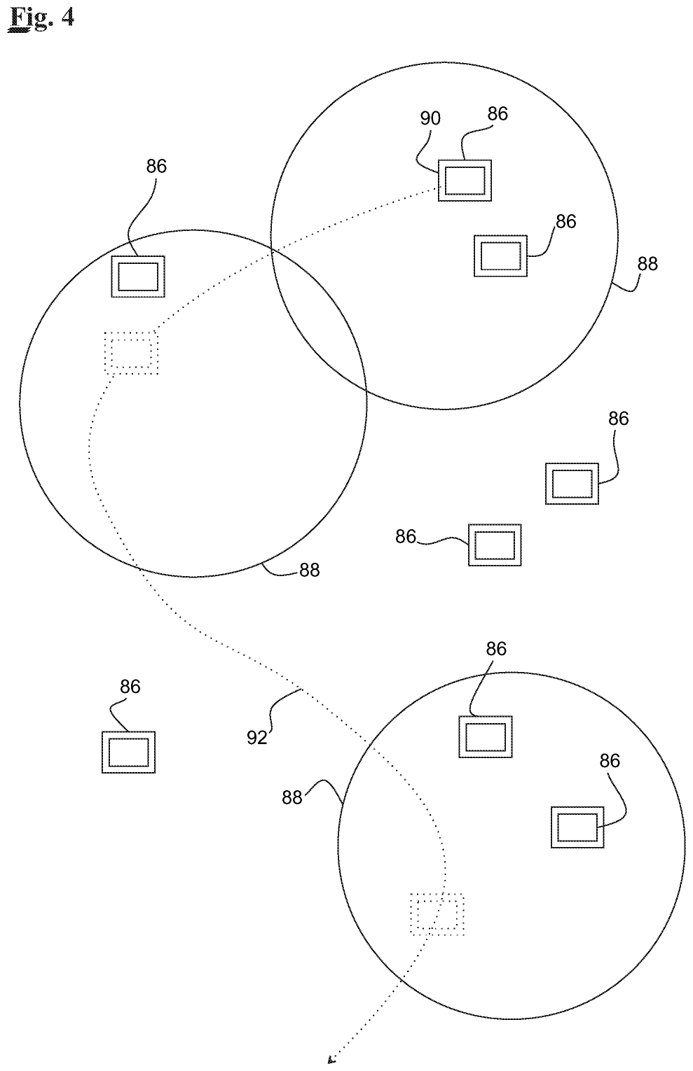

In one particularly preferred arrangement the personal information 28 comprises a WIFI network password. This relates to the embodiment shown in relation to FIG. 3. FIG. 3 illustrates a computer implemented method 60 according to another preferred embodiment of the present invention.

Referring to FIG. 3, the method 60 at block 62 provides a number of USB flash drives 65 each having a first partition 66 and a second partition 68. Each first partition 66 comprises a read only partition 66 storing an operating system configured to be loaded upon booting a computer using the USB device. Each second partition 68 comprises a read-write partition 68 for storing authentication data 72. The authentication data 72 comprises WIFI network password data 72.

The method 60 at block 74, in connection with each USB device 65 includes encrypting WIFI network password data 72 with computer identifying information 76 that uniquely identifies a computer that is associated with the corresponding USB device 65.

The computer identifying information 76 comprises the computer motherboard serial number of the corresponding computer. The computer motherboard serial number is read by the operating system stored on the first partition 66 during booting of the operating system on the host computer. The hardware motherboard serial number 78 forms the encryption key 78 that is used at block 74. The encryption uses the encryption key 78 to encrypt the WIFI network password data 72 to provide encrypted passwords. Various encryption techniques including AES encryption are able to be readily used in provision of the method 60.

Block 74 provides encrypted WIFI network authentication data 80. At block 82 the method 60 includes storing the encrypted WIFI network authentication data 80 in the second partition of the corresponding USB device 65. At block 84 the method 10 includes retrieving the WIFI network password data by reading the encrypted WIFI network authentication data 80 from the second partition 68 or the corresponding USB device 65 and applying the encryption key 78 (as a decryption key 78) to the encrypted WIFI network authentication data 80. The computer identifying information 76 is used as a decryption password.

Each of the USB flash devices 65 is used to store the WIFI password of a WIFI network that the corresponding computer is able to connect to. In this manner users are able to use their USB device 65 to logon to a WIFI network and have the password of the WIFI network saved in the second partition 68 of the corresponding USB device 65. The second partition 68 of each USB device 65 in effect provides an authentication partition 68.

Each USB device 65 provides a dedicated storage device that stores an operating system in a read only partition and stores authentication data for WIFI networks in an authentication partition. This is performed in the context of the provision of a secured remote desktop for banking operations. As discussed, the locked down system environment provided by the operating system is directed toward preventing third party attacks. The operating system provides no more than is necessary for remote desktop services with authentication to limit the attack surface.

In one particularly preferred embodiment a custom operating system is limited to providing remote protocol functionality that connects to a virtual computer service. The remote protocol functionality may be a custom remote protocol functionality or one of NX, RDP, ICA. These protocols are distinguished in that they have the ability to provide a remote desktop of some form. In this embodiment, the remote desktop is limited to providing a banking application running on the remote desktop with only the banking application being accessible by the user. On the virtual service a browser is hosted that can access the bank via the Internet. The bank could of course be connected to by VPN or dialup connection.

Among other things, it is considered that the USB flash devices 65 are distinguished from those described in International patent application PCT/AU2015/050758 by the provision of each USB device having a read-write authentication area where a unique identifier of a corresponding computer is used to encrypt a WIFI password of a WIFI network. In embodiments that relate to BITCOIN the private key does not relate specifically to a network associated with the computer. However, the nature of the types of information are similar in that both provide a key.

It has been found that an authentication area does not have to be particularly large to store one or more WIFI passwords encrypted using identifiers of computers associated with the corresponding USB device. The authentication area could be between 1 to 4 MB for example. In some embodiments, the authentication area is no more than 10 MB in size. In other embodiments, the authentication area is no more than 5 MB in size. The size of the partition of the first area may be greater than 400 MB in size. Notably the applicant is not presently aware of any systems providing access to say banking information through a remote desktop by booting a USB device where personal information is associated with the computer identifying information to provide encrypted personal information. Nor is the applicant aware of such systems decrypting special authentication data using the same computer identifying decryption password where the personal information comprises a WIFI network password.

FIG. 4 provides an illustration of the working of the method 60 illustrated in FIG. 3. In FIG. 4 there are provided a number of computers 86 and several WIFI networks 88. A laptop 90 comprises one of the computers 86 and is moved along a path 92. As the laptop moves from a first WIFI network 94 to a second WIFI network 96 to a third WIFI network 98 , the user will have to initially enter the password for each network. The motherboard identifier of the laptop computer will however be used to encrypt the various WIFI passwords and store them in the read-write partition of the corresponding USB device. Thus, if the USB is stolen or lost, it will not be able to be used to connect of the WIFI networks 94, 96 and 98 without the laptop 90. This is considered to be particularly advantageous in the context of USB devices providing locked down operating system that provide remote desktops for banking operations.

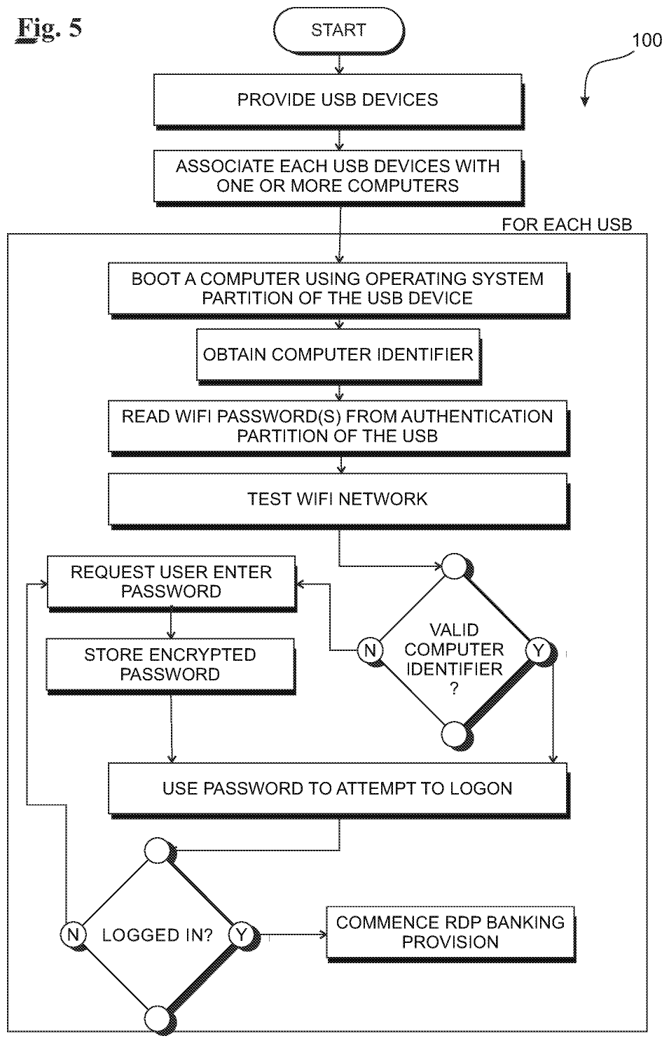

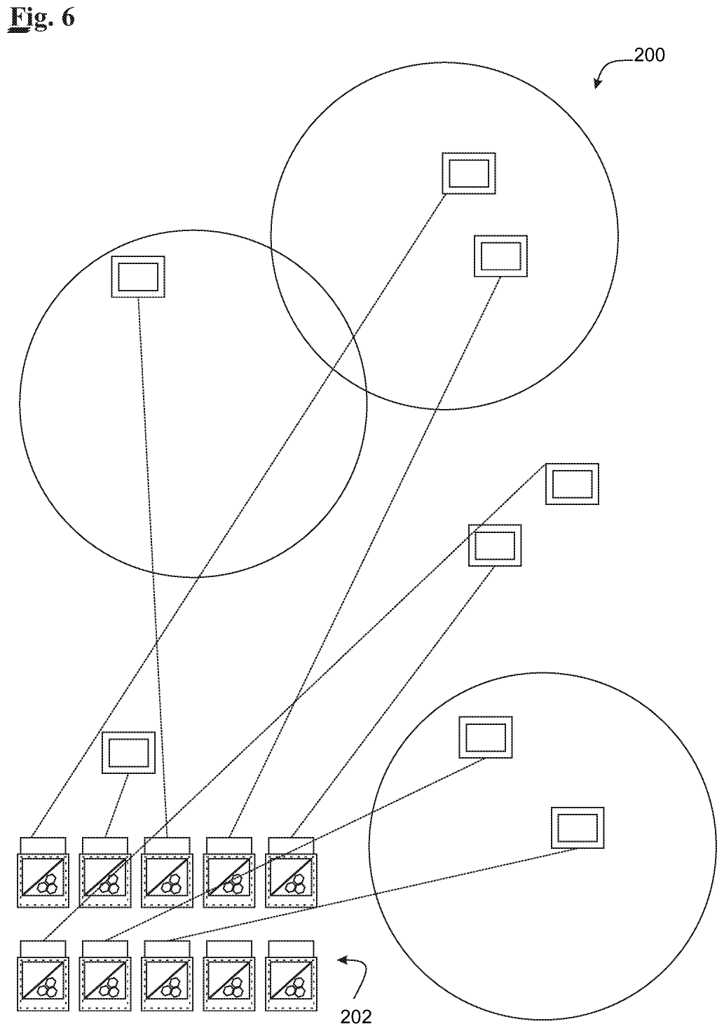

FIG. 5 illustrates a method 100 according to a further embodiment of the present invention. The method 100 comprises providing a number of USB devices that can be plugged into a number of computers. The USB devices are associated with one or more computers using a registration method providing access to online bank accounts only if the USB is used to boot those computers. The method 100 advantageously employs the method 60 described above.

In connection with the USB devices, each USB is used to boot a computer using an operating system partition of the USB device. The operating system obtains a unique identifier from the corresponding computer. The operating system reads encrypted Wi-Fi password information from an authentication partition of the USB device. The Wi-Fi password information is tested by attempting to decrypt the Wi-Fi password information using the unique identifier as a decryption password. If it is determined that the computer identifier is able to decrypt the encrypted Wi-Fi password information, the operating system attempts to log onto the corresponding WIFI network. If the operating system is able to log onto the Wi-Fi network, the operating system commences a Remote Desktop protocol procedure that attempts to provide a Remote Desktop providing dedicated access to a bank account. In the manner described the method 100 includes booting a computer using the operating system area of a corresponding USB device, when the computer identifying information corresponds with the computer, and then automatically logs onto the associated WIFI network using the WIFI password. The approach of the method 100 is further detailed in FIG. 5.

The computer identifying information is unique to a corresponding host computer with the WIFI network information being effectively locked to a particular host computer due to the computer identifying information. In some embodiments, the WIFI network information could comprise sets of WIFI network information each corresponding to a different host computer. A one to one association between the host computer and the USB device is presently preferred in situations requiring high security.

By virtue of the operating system areas being read only, any changes to the operating system area are always lost when the host computer is powered off or rebooted. Comparatively information stored in the authentication partition is persistent between reboots and power cycles of the host computer.

In this embodiment, the form of the encryption comprises Advanced Encryption Standard (AES) 256-bit encryption keys with a cypher block chaining mode of operation.

In one presently preferred embodiment the client software consists of a customised GNU/Linux distribution installed and distributed on a USB stick as a Live USB install. The USB stick is partitioned with: (i) a first partition comprising a bootable, read-only FAT32 partition with Operating System files and the bank access remote desktop client software; and (ii) a second Partition comprising a read/write EXT3 partition for storing Wi-Fi passwords.

With the first partition any changes to this partition are lost when the host computer is powered off or rebooted. With the second partition passwords are persistent on the USB stick between reboots and power cycles of the host computer.

In terms of the process: (i) Each user selects a Wi-Fi network SSID; (ii) the User enters a plain text password into the client software; (iii) the software connects to the Wi-Fi SSID with the plain text password; (iv) if there is success the process continues at (v); (iv) if there is failure the process continues at (ii); (v) the plain text password is combined with a unique hardware identifier using an encryption algorithm with the hardware identifier comprising the encryption password to produce an encrypted password; (vi) the encrypted password is written as a file to the read-write partition; (vi) there is a an eboot/power cycle host computer; (vii) the encrypted password is read from the read-write partition; (viii) the encrypted password and unique hardware identifier are passed to a decryption algorithm that uses the unique hardware identifier as a decryption password; (ix) upon a successful decryption the plain text password is used to connect the SSID; upon failure the process continues at (i). This process is repeated for multiple USB devices.

In the system, Wi-Fi passwords are encrypted via the Advanced Encryption Standard (AES) with 256 bit encryption keys and CBC mode of operation. The size of the encryption key and the mode of operation are predetermined. More specifically, Wi-Fi passwords are stored on a EXT3 file system with of a small size (5-10 MB). Wi-Fi passwords are stored in a separate partition to the Live USB operating system files. The unique hardware identifier (such as CPU serial number, or network MAC address) is used as the cypher when encrypting a Wi-Fi password.

Advantageously, Wi-Fi passwords persist between reboots of the Live USB system and are locked to a particular host computer. Moving the USB to a different host computer from the one that Wi-Fi password have been saved on does not unlock the plain text version of the encrypted password. Wi-Fi passwords are stored in an AES encrypted form, and not plain text, so are not immediately usable by outside viewers.

In relation to a computer various unique hardware identifiers may be used other than the motherboard serial number. For example, a CPU serial number or network MAC address associated with a corresponding computer could be used.

Whilst an embodiment has been described with particular regard to WIFI network passwords, other embodiments may encrypt personal information that is provided in the form of an electronic wallet, a block-chain private key, or other financial information.

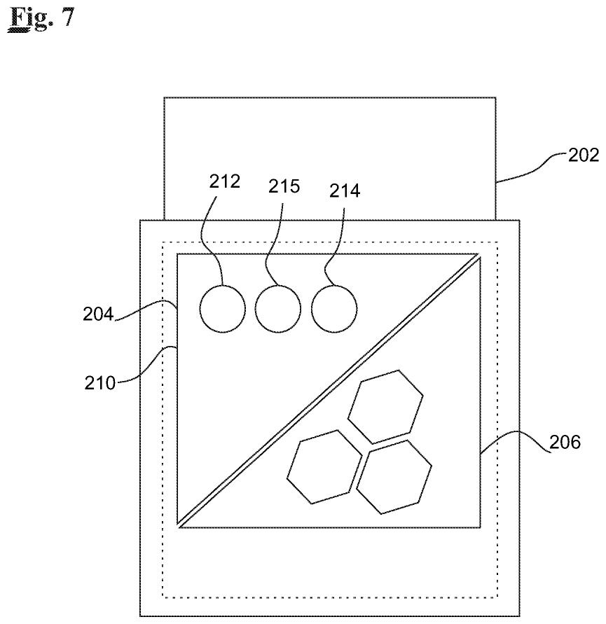

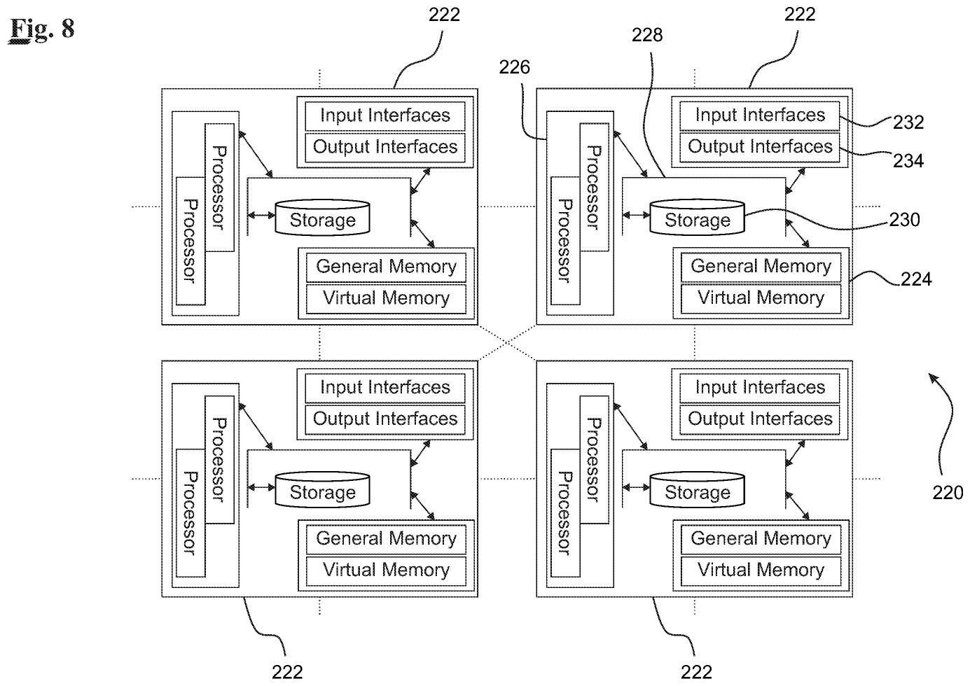

Referring to FIGS. 6 and 7 there is shown a computer implemented system 200 according to another preferred embodiment of the present invention. The computer implemented system 200 includes: a plurality of USB devices 202 each having a first partition 204 and a second partition 206 (See FIG. 7). Each first partition 204 stores an operating system 210 configured to be loaded upon booting a computer using the USB device 202. Each first partition 204 comprises a read only partition. Each second partition 206 comprises a read-write partition. Each operating system includes an encryption facility 212 for encrypting WIFI network password data with computer identifying information that uniquely identifies a computer to provide encrypted WIFI network authentication data.

Each operating system 210 includes a storage facility 215 for storing the encrypted WIFI network authentication data in the second partition 206.

Each operating system 210 further includes a retrieval facility 214 for retrieving said WIFI network password data by: (i) reading the encrypted WIFI network authentication data from the second partition; and (ii) applying the computer identifying information to the encrypted WIFI network authentication data by using the computer identifying information as a decryption password.

Each USB device provides a further embodiment comprising: a first partition 204 and a second partition 206 having the encryption facility 212, the storage facility 215 and the retrieval facility 214. The operating system can be considered as providing an associator for associating personal information (the WIFI passwords) with computer identifying information to provide special personal information.

In another embodiment there is provided a method and system. In the embodiment there are provided a plurality of mobile electronics devices in the form of USB storage devices. Each device has a data store comprising a first area.

The embodiment includes providing an external data store external to the mobile electronics devices. Each first area comprises a system area and in particular an operating system area for running on an authorised host computer.

The external data store is provided by an external system such as a cloud based system. The external data store is provided for storing personal information in the form of confidential data such as banking account information.

The embodiment includes: in connection with each mobile electronic device: associating personal information with computer identifying information to provide special personal information. The special personal information is stored in the external data store. The personal information is retrieved by: (i) reading the special personal information from the external data store; and (ii) applying the computer identifying information to the special personal information.

More particularly each USB device uses computer identifying information determined by the operating system when running on a host computer to decrypt the special personal information which in this example comprises banking account information.

In other embodiments an system external to each mobile electronics device is used to take the computer identifying information of the host computer when operating system is loaded onto the computer and decrypt the special personal information. This way, the data when stored on the external data store is tied to a computer that is authorised to use the USB device.

Each operating system is used in provision of a secured remote desktop for banking operations. As discussed, the locked down system environment provided by the operating system is directed toward preventing third party attacks. The operating system provides no more than is necessary for remote desktop services with authentication to limit the attack surface.

In another embodiment there is provided a method including: (i) providing users with user accounts; (ii) providing the users with first virtual machines in association with local electronic devices of the users; (iii) receiving user data from the users where each user is provided with the ability to store data in association with the user account of the user; and (iii) encrypting the user data of each user based on computer identifying information of an associated local electronics device of the user. The local electronic device of the user is an authorised device and the computer identifying information of the local electronics device is used the encrypt the user data.

More particularly the computer identifying information of each local electronics device comprises a unique hardware identifier of the local electronics device. The method further includes storing the unique hardware identifiers the local electronics devices in a data store of encryption keys; and associating the encryption keys with corresponding user accounts.

The method includes decrypting the data of each user based on the unique hardware identifier of the associated local electronics device of the user.

In this embodiment the user data comprises financial data.

Referring to FIG. 8 there is shown a schematic diagram of a computer system 220 that is configured to provide preferred arrangements of systems and methods described herein. The computer system 220 is provided as a distributed computer environment containing a number of individual computer systems 222 (computers/computing devices) that cooperate to provide the preferred arrangements. In other embodiments the computer system 220 is provided as a single computing device.

As shown, a first one of the computing devices 222 includes a memory facility 224. The memory facility 224 includes both ‘general memory’ and other forms of memory such as virtual memory. The memory facility 224 is operatively connected to a processing facility 226 including at least one processor. The memory facility 224 includes computer information in the form of executable instructions and/or computer data. The memory facility 224 is accessible by the processing facility 226 in implementing the preferred arrangements.

As shown each of the computing devices 422 includes a system bus facility 228, a data store facility 230, an input interface facility 232 and an output interface facility 234. The data store facility 230 includes computer information in form of executable instructions and/or computer data. The data store facility 230 is operatively connected to the processing facility 226. The data store facility 230 is operatively connected to the memory facility 224. The data store facility 230 is accessible by the processing facility 226 in implementing the preferred arrangements.

Computer information may be located across a number of devices and be provided in a number of forms. For example the data store facility 230 may include computer information in the form of executable instructions and/or computer data. The computer data information may be provided in the form of encoded data instructions, data signals, data structures, program logic for server side operation, program logic for client side operation, stored webpages and so forth that are accessible by the processing facility 226.

On one level, input interfaces allow computer data to be received by the computing devices 222. On another level, input interfaces allow computer data to be received from individuals operating one or more computer devices. Output interfaces, on one level, allow for instructions to be sent to computing devices. On another level, output interfaces allow computer data to be sent to individuals. The input and output interface facilities 232, 234 provide input and output interfaces that are operatively associated with the processing facility 226. The input and output facilities 232, 234 allow for communication between the computing devices 222 and individuals.

The computing devices 222 provide a distributed system in which several devices are in communication over network and other interfaces to collectively provide the preferred arrangements. Preferably there is provided at least one client device in the system of computing devices 222 where the system is interconnected by a data network.

The client device may be provided with a client side software product for use in the system which, when used, provides systems and methods where the client device and other computer devices 222 communicate over a public data network. Preferably the software product contains computer information in the form of executable instructions and/or computer data for providing the preferred arrangements.

Input interfaces associated with keyboards, mice, trackballs, touchpad's, scanners, video cards, audio cards, network cards and the like are known. Output interfaces associated with monitors, printers, speakers, facsimiles, projectors and the like are known. Network interfaces in the form of wired or wireless interfaces for various forms of LANs, WANs and so forth are known. Storage facilities in the form of floppy disks, hard disks, disk cartridges, CD-ROMS, smart card, RAID systems are known. Volatile and non-volatile memory types including RAM, ROM, EEPROM and other data storage types are known. Various transmission facilities such as circuit board material, coaxial cable, fibre optics, wireless facilities and so forth are known.

It is to be appreciated that systems, components, facilities, interfaces and so forth can be provided in several forms. Systems, components, facilities, interfaces and so forth may be provided as hardware, software or a combination thereof. The present invention may be embodied as an electronics device, computer readable memory, a personal computer and distributed computing environments.

In addition the present invention may be embodied as: a number of computer executable operations; a number of computer executable components; a set of process operations; a set of systems, facilities or components; a computer readable medium having stored thereon computer executable instructions for performing computer implemented methods and/or providing computer implemented systems; and so forth. In the case of computer executable instructions they preferably encode the systems, components and facilities described herein. For example a computer-readable medium may be encoded with one or more facilities configured to run an application configured to carry out a number of operations forming at least part of the present arrangements. Computer readable mediums preferably participate in the provision of computer executable instructions to one or more processors of one or more computing devices.

Computer executable instructions are preferably executed by one or more computing devices to cause the one or more computing devices to operate as desired. Preferred data structures are preferably stored on a computer readable medium. The computer executable instructions may form part of an operating system of a computer device for performing at least part of the preferred arrangements. One or more computing devices may preferably implement the preferred arrangements.

The term computer is to be understood as including all forms of computing device including servers, personal computers, smart phones, digital assistants, electronics devices and distributed computing systems.

Computer readable mediums and so forth of the type envisaged are preferably intransient. Such computer readable mediums may be operatively associated with computer based transmission facilities for the transfer of computer data. Computer readable mediums may provide data signals. Computer readable mediums preferably include magnetic disks, optical disks and other electric/magnetic and physical storage mediums as may have or find application in the industry.

Components, systems and tasks may comprise a process involving the provision of executable instructions to perform a process or the execution of executable instructions within say a processor. Applications or other executable instructions may perform method operations in different orders to achieve similar results. It is to be appreciated that the blocks of systems and methods described may be embodied in any suitable arrangement and in any suited order of operation. Computing facilities, modules, interfaces and the like may be provided in distinct, separate, joined, nested or other forms and arrangements. Methods will be apparent from systems described herein and systems will be apparent from methods described herein.

As would be apparent, various alterations and equivalent forms may be provided without departing from the spirit and scope of the present invention. This includes modifications within the scope of the appended claims along with all modifications, alternative constructions and equivalents.

There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’, ‘or’ and ‘having’ are to be construed in an inclusive rather than an exclusive sense.

It is to be recognised that any discussion in the present specification is intended to explain the context of the present invention. It is not to be taken as an admission that the material discussed formed part of the prior art base or relevant general knowledge in any particular country or region.

1. A computer implemented method comprising: (A) providing at least one mobile electronics device, each device having a data store comprising a first area and a second area; the second area being distinct from the first area to assist with securing the first area; the first area being a system area and the second area for storing personal information; and (B) in connection with each mobile electronic device: associating personal information with computer identifying information to provide special personal information; storing the special personal information in the second area; and retrieving the personal information by: (i) reading the special personal information from the second area; and (ii) applying the computer identifying information to the special personal information.

2. A computer implemented method as claimed in claim 1 wherein the first area comprises a locked down system area; the second area comprises an authentication area and the personal information comprises authentication data.

3. A computer implemented method as claimed in claim 1 or 2 wherein in connection with each mobile electronic device: the first area comprises a read-only partition; and the second area comprises a read-write partition.

4. A computer implemented method as claimed in any one of claims 1 to 3 wherein the personal information comprises password, wallet or key data.

5. A computer implemented method as claimed in any one of claims 1 to 3 wherein the personal information comprises personal financial data.

6. A computer implemented method as claimed in any one of claims 1 to 3 wherein the personal information comprises a WWI network password.

7. A computer implemented method as claimed in any one of claims 1 to 3 wherein each mobile electronic device comprises a dedicated storage device.

8. A computer implemented method as claimed in claim 7 wherein the dedicated storage device comprises a USB thumb drive.

9. A computer implemented method as claimed in any one of claims 1 to 8 wherein the first area comprises a locked down system area; the second area comprises an authentication area;
and the authentication area is no more than 10 MB in size.

10. A computer implemented method as claimed in any one of claims 1 to 9 wherein the first area comprises a locked down system area; the second area comprises an authentication area;
and the authentication area is no more than 5 MB in size.

11. A computer implemented method as claimed in any one of claims 1 to 10 wherein the first area comprises a locked down system area; the second area comprises an authentication area;
and the authentication area is greater than 1 MB in size.

12. A computer implemented method as claimed in any one of claims 1 to 11 wherein the first area comprises a locked down system area; the second area comprises an authentication area;
and the operating system area is greater than 400 MB in size.

13. A computer implemented method as claimed in any one of claims 1 to 12 wherein associating the personal information with the computer identifying information to provide the special personal information comprises encrypting the personal information using the computer identifying information as the encryption password.

14. A computer implemented method as claimed in any one of claims 1 to 13 wherein applying computer identifying information to the special personal information comprises decrypting the special authentication data using the computer identifying information.

15. A computer implemented method as claimed in any one of claims 1 to 14 wherein the personal information comprises a WIFI network password.

16. A computer implemented method as claimed in claim 15 wherein the first area comprises a locked down operating system area; the second area comprises an authentication area; and
the method includes, in connection with each mobile electronic device, booting a computer using the operating system area and, when the computer identifying information corresponds with the computer, automatically logging onto the associated WIFI network using the WIFI password.

17. A computer implemented method as claimed in claim 15 or 16 wherein the first area comprises a locked down operating system area; the second area comprises an authentication area; the operating system area comprises a read-only partition and the authentication area comprises a read-write partition; associating the WIFI network password with the computer identifying information to provide the special authentication data comprises encrypting the WIFI network password using the computer identifying information as the password; and applying computer identifying information to the special authentication data comprises decrypting the special authentication data using the computer identifying information.

18. A computer implemented method as claimed in any one of claims 1 to 17 wherein the computer identifying information is unique to a corresponding host computer such that the personal information of each mobile device is locked to a particular host computer due to the computer identifying information.

19. A computer implemented method as claimed in any one of claims 1 to 18 wherein any changes to the first area are lost when the host computer is powered off or rebooted; and the personal information of the second area is persistent between reboots and power cycles of the host computer.

20. A computer implemented method as claimed in any one of claims 1 to 19 wherein the personal information is encrypted via the Advanced Encryption Standard (AES) with 128 or more encryption keys with a cypher block chaining mode of operation.

21. A computer implemented method as claimed in any one of claims 1 to 20 wherein the computer identifying information comprises a unique hardware identifier.

22. A computer implemented method as claimed in claim 21 wherein the unique hardware identifier comprises a CPU serial number or network MAC address associated with a corresponding computer.

23. A computer implemented method as claimed in any one of claims 1 to 22 wherein the personal information comprises an electronic wallet.

24. A computer implemented method as claimed in any one of claims 1 to 23 wherein the personal information comprises a block-chain private key.

25. A computer implemented method as claimed in claim 24 wherein the personal information comprises a block-chain private key for electronic money.

26. A computer implemented method as claimed in any one of claims 1 to 25 wherein the personal information comprises a private key.

27. A computer implemented method comprising: (A) providing at least one mobile electronics device, each device having a data store comprising an operating system area and an authentication area; the authentication area being distinct from the operating system area to assist with securing the operating system area; the authentication area for storing authentication data; and (B) in connection with each mobile electronic device: associating authentication data with computer identifying information to provide special authentication data; storing the special authentication data in the authentication area; and retrieving said authentication data by: (i) reading the special authentication data from the authentication area; and (ii) applying the computer identifying information to the special authentication data.

28. A computer implemented method comprising the steps of: (A) providing USB devices having a first partition and a second partition; each first partition storing an operating system configured to be loaded upon booting a computer using the USB device; each first partition being a read only partition; each second partition being a read-write partition; (B) in connection with each USB device: encrypting WIFI network password data with computer identifying information that uniquely identifies a computer to provide encrypted WIFI network authentication data; storing the encrypted WIFI network authentication data in the second partition; and retrieving said WIFI network password data by: (i) reading the encrypted WIFI network authentication data from the second partition; and (ii) applying the computer identifying information to the encrypted WIFI network authentication data by using the computer identifying information as a decryption password.

29. A computer implemented system comprising: a plurality of USB devices each having a first partition and a second partition; each first partition storing an operating system configured to be loaded upon booting a computer using the USB device; each first partition being a read only partition; each second partition being a read-write partition; each operating system including: (A) an encryption facility for encrypting WIFI network password data with computer identifying information that uniquely identifies a computer to provide encrypted WIFI network authentication data; (B) a storage facility for storing the encrypted WIFI network authentication data in the second partition; and (C) a retrieval facility for retrieving said WIFI network password data by: (i) reading the encrypted WIFI network authentication data from the second partition; and (ii) applying the computer identifying information to the encrypted WIFI network authentication data by using the computer identifying information as a decryption password.

30. A storage device comprising: a first area and a second area; the second area being distinct from the first area to assist with securing the first area; the first area being a system area and the second area for storing personal information; the first area including: (A) an associator for associating personal information with computer identifying information to provide special personal information; (B) a storage facility for storing the special personal information data in the second area; and (C) a retrieval facility for retrieving said personal information by: (i) reading the special personal information from the second area; and (ii) applying the computer identifying information to the special personal information.

31. A storage device comprising: a first partition and a second partition; the first partition storing an operating system configured to be loaded upon booting a computer using the USB device; each first partition being a read only partition; each second partition being a read-write partition; each operating system including: (A) an encryption facility for encrypting WIFI network password data with computer identifying information that uniquely identifies a computer to provide encrypted WIFI network authentication data; (B) a storage facility for storing the encrypted WIFI network authentication data in the second partition; and (C) a retrieval facility for retrieving said WIFI network password data by: (i) reading the encrypted WIFI network authentication data from the second partition; and (ii) applying the computer identifying information to the encrypted WIFI network authentication data by using the computer identifying information as a decryption password.

32. A computer implemented method comprising: (A) providing a plurality of mobile electronics devices, each device having a data store comprising a first area; (B) providing an external data store external to the mobile electronics devices; each first area being a system area and the external data store for storing personal information; and (C) in connection with each mobile electronic device: associating personal information with computer identifying information to provide special personal information; storing the special personal information in the external data store; and retrieving the personal information by: (i) reading the special personal information from the external data store; and (ii) applying the computer identifying information to the special personal information.

33. A computer implemented method comprising:
(i) providing users with user accounts;
(ii) providing the users with first virtual machines in association with local electronic devices of the users;
(iii) receiving user data from the users where each user is provided with the ability to store data in association with the user account of the user; and
(iv) encrypting the user data of each user based on computer identifying information of an associated local electronics device of the user.

34. A computer implemented method as claimed in claim 33 wherein the computer identifying information of each local electronics device comprises a unique hardware identifier of the local electronics device

35. A computer implemented method as claimed in claim 33 or 34 wherein the method includes storing the unique hardware identifiers the local electronics devices in a data store of encryption keys; and associating the encryption keys with corresponding user accounts.

36. A computer implemented method as claimed in claim 33, 34 or 35 wherein the method includes decrypting the data of each user based on the unique hardware identifier of the associated local electronics device of the user.

37. A method or system, run via at least one computer processor as claimed in any one of the preceding method or system claims.

38. A memory storing computer program instructions executable by a processor, the computer program instructions including instructions for performing operations comprising:

39. A non-transient computer readable medium having stored thereon computer executable instructions for performing a computer implemented method as claimed in any one of the preceding method claims.

40. A non-transient computer readable medium having stored thereon computer executable instructions encoding a computer implemented system as claimed in any one of the preceding system claims.

41. A non-transient computer-readable medium encoded with one or more facilities configured to run an application configured to carry out a number of operations to provide any one of the preceding method or system claims

42. A non-transient computer implemented method or system as claimed in any one of the preceding claims.
